(19) United States
(12) Patent Application Publication
(10) Pub. No.: US 2001/0035934 A1
(43) Pub. Date: Nov. 1, 2001

(54) Eyeglass frames with magnetical attachment mechanism at bridges

(76) Inventor: Arun Jaswant Jagasia, Chembur (IN)

Correspondence Address: NEEDLE & ROSENBERG, P.C., Suite 1200, The Candler Building, 127 Peachtree Street, N.E., Atlanta, GA, 30303-1811, US

(21) Appl. No.: 09/805,454

(22) Filed: Mar. 13, 2001

Related U.S. Application Data
(60) Provisional application No. 60/188,734, filed on Mar. 13, 2000.

(51) Int. Cl. G02C 9/00; G02C 5/02

(52) U.S. Cl. 351/47; 351/133

(57) ABSTRACT

An eyeglass device with magnetical attachment mechanism at bridges having a primary frame and a auxiliary frame. The primary frame includes a first rim and a second rim for holding a first pair of lenses, and a bridge connecting the first rim and the second rim. The auxiliary frame includes a first rim and a second rim for holding a second pair of lenses, and a bridge connecting the first rim and the second rim. The bridge of the auxiliary frame has a body, a first arm and a second arm. The body of the bridge of the auxiliary frame is extending horizontally and terminating at a first end and an opposite second end, the body having a top portion and a bottom portion, a socket located between the top portion and a bottom portion, and a magnetic member secured in the socket. Each of the first arm and the second arm of the bridge of the auxiliary frame forms a U-type hook structure with the body and one of the first rim and the second rim of the auxiliary frame, with one of the rims and the body of the bridge of the auxiliary frame being the two legs of the U-type hook structure, and one of the arms being the bottom bar of the U-type hook structure, respectively. When the auxiliary frame is detachably attached with the primary frame to form the eyeglass device, at least one U-type hook structure of the bridge of the auxiliary frame fits into the bridge of the primary frame.

### CROSS-REFERENCE TO RELATED APPLICATION

This application claims priority to U.S. Provisional Application Serial No. 60/188,734, which was filed on Mar. 13, 2000.

### BACKGROUND OF THE INVENTION

1. Field of the Invention

The present invention relates to an eyeglass device having primary and auxiliary frames with lenses and method of forming the same, more particularly to an eyeglass device having primary and auxiliary frames with lenses, in which the auxiliary frame is supported by and engaged with the primary frame magnetically and mechanically with a magnetic attachment mechanism at bridges of the primary and auxiliary frames.

2. Description of the Related Art

Use of magnetic material to engage an auxiliary frame with lenses with a primary frame with lenses is known in the art.

One common problem related to the eyeglass devices using currently available magnetic engagement mechanisms is that they often do not satisfactorily prevent the auxiliary frame from moving in various directions relative to the primary frame. Consequently, unintended disengagement of the auxiliary frame from the primary frame may happen from time to time, especially when users of the eyeglasses conduct physical exercises involving activities such as jogging, running, or jumping. Using complicated mechanical structures to provide additional support may increase cost and comprise the integrity of the eyeglass devices. Another problem related to the eyeglass device using currently available magnetic engagement mechanisms is that they often negatively affect the cosmetic design of the primary frame.

Therefore, there is a need for a new engagement mechanism for properly engaging an auxiliary frame with lenses with a primary frame with lenses.

### SUMMARY OF THE INVENTION

The disadvantages of the prior art are overcome by the present invention which provides an eyeglass device with a magnetic attachment mechanism at bridges of the primary frame and the auxiliary frame.

In one aspect of the present invention, an eyeglass device has a first and second pairs of lenses. The eyeglass device further has a primary frame and an auxiliary frame.

The primary frame includes a first rim for holding one lens of a first pair of lenses, a second rim for holding the other lens of the second pair of lenses, and a bridge connecting the first rim and the second rim. The bridge of the primary frame includes a body having an inside surface and an opposite outside surface, a housing formed on the inside surface of the body, wherein the housing has a mouth and a bottom defining a socket therebetween, and a magnetic member secured in the socket.

The auxiliary frame includes a first rim for holding one lens of the second pair of lenses, a second rim for holding the other lens of the first pair of lenses, and a bridge connecting the first rim and the second rim. The bridge of the auxiliary frame has a body, a first arm and a second arm. The body of the bridge of the auxiliary frame is extending horizontally and terminating at a first end and an opposite second end, the body having a top portion and a bottom portion, a socket located between the top portion and a bottom portion, and a magnetic member secured in the socket. The first arm of the bridge of the auxiliary frame is located at the first end of the body and projecting forward from the top portion of the body to be attached with the first rim. The second arm of the bridge of the auxiliary frame is located at the second end of the body and projecting forward from the top portion of the body to be attached with the second rim. Each of the first arm and the second arm of the bridge of the auxiliary frame forms a U-type hook structure with the body and one of the first rim and the second rim of the auxiliary frame, with one of the rims and the body of the bridge of the auxiliary frame being the two legs of the U-type hook structure, and one of the arms being the bottom bar of the U-type hook structure, respectively.

When the auxiliary frame is detachably attached with the primary frame to form the eyeglass device, the U-type hook structure of the bridge of the auxiliary frame fits into the bridge of the primary frame. Specifically, the first and second arms of the bridge of the auxiliary frame project over and is supported at least by the bridge of the primary frame to allow the body of the bridge of the auxiliary frame in contact with the bridge of the primary frame and the magnetic member of the bridge of the auxiliary frame to engage with the magnetic member of the bridge of the primary frame to separate the magnetic member of the bridge of the primary frame from the ambient air such that the auxiliary frame is disposed in front of the primary frame with each lens of the second pair of lenses being substantially in alignment with a respective lens of the first pair of lenses. The first and second pairs of lenses can have same or different optical characteristics such as focal point, color, refracting power, reflecting power, transparency, etc. In one embodiment, the first pair of the lenses are eyeglasses lenses, and the second pair of the lenses are sunglass lenses or lenses with a material or coating thereon to filter ultraviolet light or other specific wavelengths of light, or vice versa.

In yet another aspect of the present invention, an auxiliary frame is adapted to receive a first pair of lenses and be supported on a primary frame. The primary frame has a first rim for holding one lens of a first pair of lenses, a second rim for holding the other lens of the second pair of lenses, and a bridge connecting the first rim and the second rim, wherein the bridge is capable of interacting magnetically with a magnetical material.

The auxiliary frame has a first rim for holding one lens of the first pair of lenses, a second rim for holding the other lens of the second pair of lenses, and a bridge connecting the first rim and the second rim. The bridge includes a body, a first arm and a second arm. The body is extending horizontally and terminating at a first end and an opposite second end, the body having a top portion and a bottom portion, a socket located between the top portion and a bottom portion, and a magnetic member secured in the socket. The first arm is located at the first end of the body and projecting forward from the top portion of the body to be attached with the first rim. The second arm is located at the second end of the body and projecting forward from the top portion of the body to be attached with the second rim.

When the auxiliary frame is engaged with the primary frame, the first and second arms of the bridge of the auxiliary frame project over and is supported at least by the bridge of the primary frame to allow the body of the bridge of the auxiliary frame in contact with the bridge of the primary frame and the magnetic member of the bridge of the auxiliary frame to engage the bridge of the primary frame such that the auxiliary frame is disposed in front of the primary frame with each lens of the second pair of lenses being substantially in alignment with a respective lens of the first pair of lenses.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

FIGS. 1 and 3 are front views of the primary and auxiliary frames in accordance with an embodiment of the present invention respectively.

FIGS. 2 and 4 are top views of the primary frame and auxiliary frames as shown in FIGS. 1 and 3 respectively.

FIGS. 2A and 4A are partial back views of the primary frame and auxiliary frame as shown in FIGS. 1 and 3 respectively.

FIG. 5 is a top view of an eyeglass device formed according to the present invention by the primary and auxiliary frames as shown in FIGS. 1-4.

FIG. 6 shows a cross-sectional view taken along lines 6-6 of FIG. 5 in accordance with a first embodiment of the first embodiment of the present invention.

FIG. 7 shows a cross-sectional view taken along lines 6-6 of FIG. 5 in accordance with an alternative embodiment of the present invention.

### DETAILED DESCRIPTION OF THE PREFERRED EMBODIMENTS

The present invention may be understood more readily by reference to the following detailed description of preferred embodiments of the invention. Before the present articles and methods are disclosed and described, it is to be understood that the terminology used herein is for the purpose of describing particular embodiments only and is not intended to be limiting. It must be noted that, as used in the specification and the appended claims, the singular forms “a,” “an” and “the” include plural referents unless the context clearly dictates otherwise.

The present invention will now be described in detail with reference to the accompanying drawings including the texts therein, in which like numerals represent like components throughout the drawings.

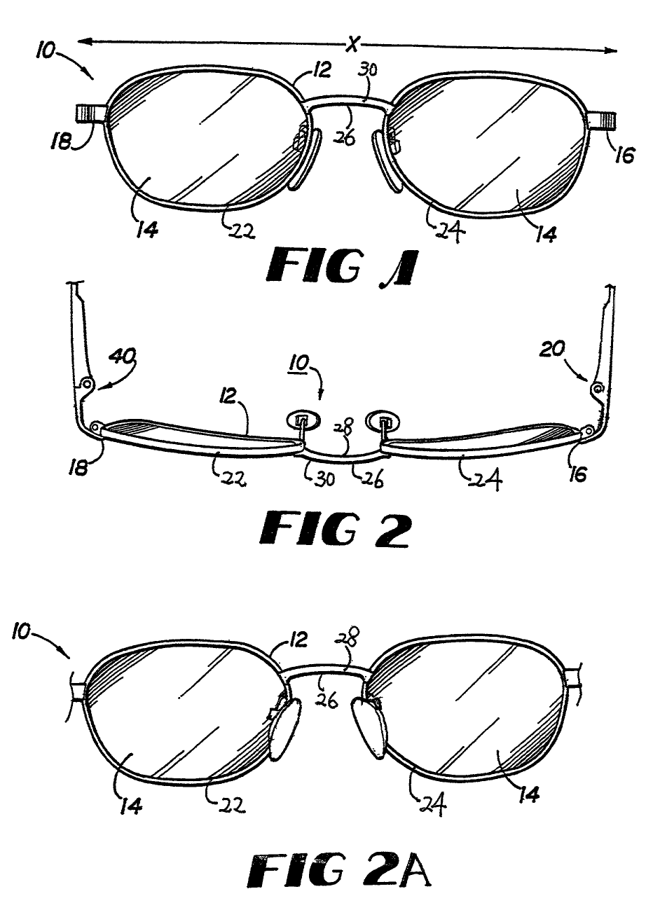

Referring initially to FIGS. 1, 2 and 2A, reference numeral 10 is a primary frame where a front portion 12 holds a pair of lenses 14. The primary frame 10 can be made of plastic, metal, a combination of both or other conventional material. The primary frame 10 can include metal support members embedded therein (not shown). The front portion 12 has two opposed ends 16, 18, defining an axis X extending from one end to another end. It will be appreciated throughout the description that the existence of the axis X should not be interpreted in any way implying that the front portion 12 always falls into one plane. Instead, in general, the front portion 12 has a more or less curved shape. Moreover, ends 16, 18 each can be an endpiece for connecting the front portion 12 with other parts of the spectacle frame 10, such as temples 20, 40.

The front portion 12 has a first rim 22, a second rim 24 and a bridge 26. The first rim 22 holds one lens of the pair of lenses 14. The second rim 24 holds the other lens of the pair of lenses 14. The bridge 26 connects the first rim 22 and the second rim 24. The bridge 26 has a body having an inside surface 28, and an opposite outside surface 30. The bridge 26 is capable of interacting magnetically with a magnetical material.

In one embodiment of the present invention, the bridge 26 is made from steel such as stainless steel, which can be magnetically attracted by a magnet and/or magnetized. When the bridge 26 is magnetically attracted by a magnet and/or magnetized, it can attract other iron or steel objects including stainless steel objects.

In another embodiment of the present invention, as shown partially in FIG. 7, the bridge 26 has a housing 33 formed on the inside surface 28 of the bridge 26. The housing 33 has a mouth 35 and a bottom 37 defining a socket 34 therebetween to receive and secure the magnetic member 36. The bottom 37 of the housing 33 and the outside surface 30 are separated by a portion of the body of the bridge 26 so that the magnetic member 36 received in the socket 34 may only communicate with ambient air at the mouth 35. Th socket 34 can be substantially rectangular cross-sectionally, as shown in FIG. 7. Alternatively, the socket 34 can have geometric shape other than rectangular cross-sectionally, such as oval, circular, diamond, square, etc.

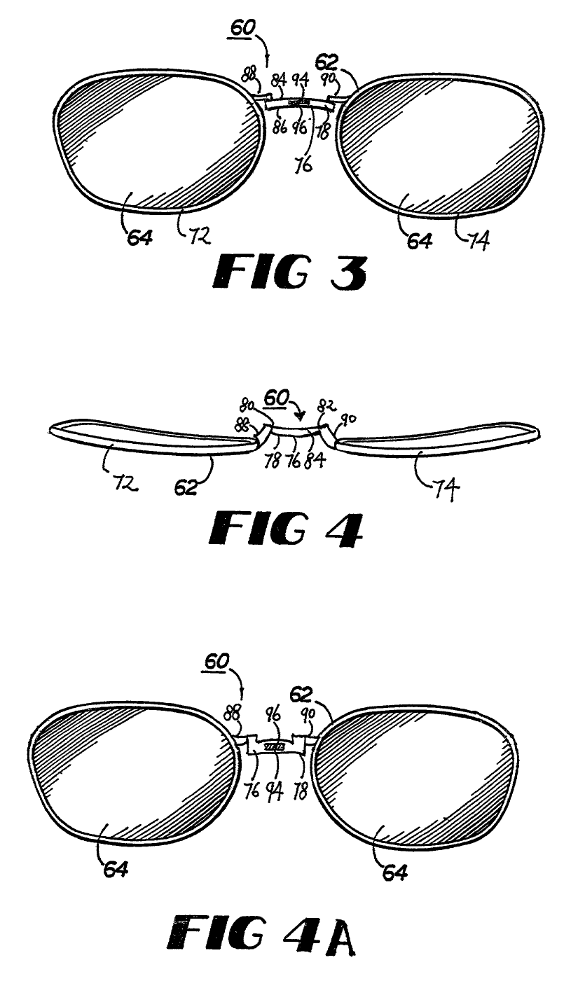

Referring now to FIGS. 3, 4 and 4A, reference numeral 60 is an auxiliary frame where a first rim 72 holds one lens of a pair of lenses 64, and a second rim 74 holds the other lens of the pair of lenses 64, respectively. The auxiliary frame 60 can be made of plastic, metal, a combination of both or other conventional material. The auxiliary frame 60 can include metal support members embedded therein (not shown). Among other things, one use for the auxiliary frame 60 is to provide protection to the wearer from sunlight and/or other vision damaging elements. Therefore, the auxiliary frame 60 may have tinted lenses with a tint that is darker than the tint of lenses of the primary frame 10, and may also include material therein or a coating thereon to filter ultraviolet light or other specific wavelengths of light. The auxiliary frame 60 may also be used to provide a complimentary pair of lenses, which, in combination with the lenses of the primary frame 10, provides an eyeglass device fitting to the needs of the wearer. Thus, the pair of lenses of the auxiliary frame 60 and the pair of lenses of the primary frame 10 can have same or different optical characteristics such as focal point, color, refracting power, reflecting power, transparency, etc. The pair of lenses of the auxiliary frame 60 and the pair of lenses of the primary frame 10 can be made from same or different materials. Furthermore, the lenses of each of the pair of lenses of the auxiliary frame 60 and the pair of lenses of the primary frame 10 can have different or same optical characteristics.

The auxiliary frame 60 further includes a bridge 76 connecting the first rim 72 and the second rim 74. In one embodiment of the present invention, the bridge 76 has a body 78 extending horizontally and terminating at a first end 80 and an opposite second end 82. The body 78 has a top portion 84 and a bottom portion 86. A socket 94 is located between the top portion 84 and the bottom portion 86. A magnetic member 96 is secured in the socket 94.

Still referring to FIGS. 3, 4 and 4A, the bridge 76 has a first arm 88 extended from the first end 80 of the body 78 and projecting forward from the top portion 84 of the body 78 to reach and be attached with the first rim 72. Additionally, the bridge 76 has a second arm 90 extended from the second end 82 of the body 78 and projecting forward from the top portion 84 of the body 78 to reach and be attached with the second rim 74. In the embodiment shown in FIGS. 3, 4 and 4A, the first arm 88 and the second arm 90 of the bridge 76 are aligned opposite to each other. Each of the first arm 88 and the second arm 90 of the bridge 76 forms a U-type hook structure with the body 78 and one of the first rim 72 and the second rim 74 of the auxiliary frame 60, with one of the rims 72, 74 and the body 78 of the bridge 76 of the auxiliary frame 60 being the two legs of the U-type hook structure, and one of the arms 88, 90 being the bottom bar of the U-type hook structure, respectively. Thus, the bridge 76 has two U-type hook structures.

The auxiliary frame 60 can be detachably attached to the front of the primary frame 10 to form an eyeglass device 100. As shown in FIGS. 5, 6 and 7, when the auxiliary frame 60 is engaged with or put on the front of the primary frame 10, at least one of the U-type hook structure of the bridge 76 of the auxiliary frame 60 fits into the bridge 26 of the primary frame 10. More specifically, the first arm 88 and second arm 90 of the bridge 76 of the auxiliary frame 60 project over, respectively, and is supported at least by the bridge 26 of the primary frame 10 to allow the body 78 of the bridge 76 of the auxiliary frame 60 in contact with the bridge 26 of the primary frame 10 and the magnetic member 96 of the bridge 76 of the auxiliary frame 60 to engage the bridge 26 of the primary frame 10 such that the auxiliary frame 60 is disposed in front of the primary frame 10 with each lens of the pair of lenses 64 being substantially in alignment with a respective lens of the pair of lenses 14. In other words, the U-type hook structures of the bridge 76 of the auxiliary frame 60 fit into the bridge 26 of the primary frame 10 for a stable engagement.

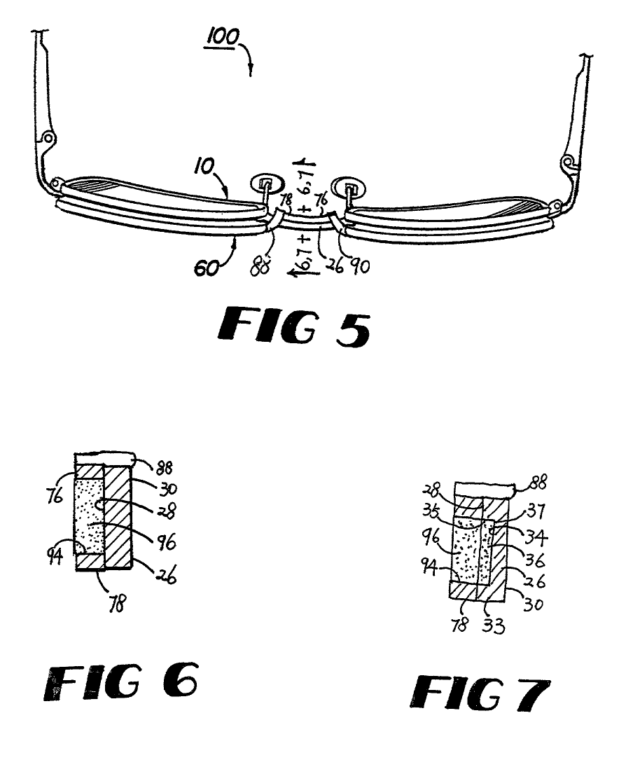

The magnetic engagement mechanism between the magnetic member 96 of the bridge 76 of the auxiliary frame 60 and the bridge 26 of the primary frame 10 can be achieved in several ways. For example, as shown partially in FIG. 6, where the bridge 26 is made from steel such as stainless steel, the magnetic member 96 of the bridge 76 of the auxiliary frame 60 attracts and may partially magnetize the bridge 26 of the primary frame 10 so that the bridge 76 of the auxiliary frame 60 and the bridge 26 of the primary frame 10 are magnetically engaged together. Note that the bridge 26 of the primary frame 10 provides additional support to the bridge 76 of the auxiliary frame 60 through the first arm 88 and the second arm 90 (not shown in FIG. 6).

In another embodiment of the present invention, as shown partially in FIG. 7, where the bridge 26 has a magnetic member 36 secured in a socket 34, the magnetic member 96 of the bridge 76 of the auxiliary frame 60 engages the magnetic member 36 of the primary frame 10 side by side. Additionally, the bridge 26 of the primary frame 10 provides additional support to the bridge 76 of the auxiliary frame 60 through the first arm 88 and the second arm 90 (not shown in FIG. 7). Thus, the auxiliary frame 60 is stably supported by the primary frame 10 both mechanically and magnetically. Moreover, as shown in FIG. 7, the magnetic member 36 of the primary frame 10 is separated from the ambient air by the magnetic member 96 and a portion of the body of the bridge 26, when the auxiliary frame 60 is in proper engagement with the primary frame 10, to offer an eyeglass device 100 with attractive appearance.

In the embodiment as shown in FIG. 5, the primary frame 10 and the auxiliary frame 60 are previously designed to have the proper size relative to each other so that there is a complimentary fit between them to form a uniform appearance.

In the embodiments as shown in FIGS. 6 and 7, magnetic members 36 and 96 are rectangular cross-sectionally. Alternatively, the magnetic members 36 and 96 cross-sectionally can take geometric shapes other than rectangle. The magnetic members used in the present invention are made from magnetic materials known in the art. The magnetic members 36 and 96 can be same or different, material-wise, shape-wise or size-wise. Each of the magnetic members in connection with the present invention can be a magnet, or made of a magnetic material such as a permanent magnetic material or a ferromagnetic material.

Other embodiments of the invention will be apparent to those skilled in the art from consideration of the specification and practice of the invention disclosed herein. It is intended that the specification and examples be considered as exemplary only.

What is claimed is:

1. An auxiliary frame adapted to receive a first pair of lenses and be supported on a primary frame, which has:
(i). a first rim for holding one lens of a second pair of lenses;
(ii). a second rim for holding the other lens of the second pair of lenses; and
(iii). a bridge connecting the first rim and the second rim, wherein the bridge is capable of interacting magnetically with a magnetical material,
the auxiliary frame comprising:
(i). a first rim for holding one lens of the first pair of lenses;
(ii). a second rim for holding the other lens of the first pair of lenses;
(iii). a bridge connecting the first rim and the second rim, the bridge comprising:
a. a body extending horizontally and terminating at a first end and an opposite second end, the body having a top portion and a bottom portion, a socket located between the top portion and the bottom portion, and a magnetic member secured in the socket;
b. a first arm located at the first end of the body and projecting forward from the top portion of the body to be attached with the first rim; and
c. a second arm located at the second end of the body and projecting forward from the top portion of the body to be attached with the second rim,
Wherein each of the first arm and the second arm forms a U-type hook structure with the body and one of the first rim and the second rim of the auxiliary frame, with one of the first and second rims and the body of the bridge of the auxiliary frame being the two legs of the U-type hook structure and one of the arms being the bottom bar of the U-type hook structure respectively; and
when the auxiliary frame is engaged with the primary frame, at least one U-type hook structure of the bridge of the auxiliary frame fits into the bridge of the primary frame and the first and second arms of the bridge of the auxiliary frame project over and is supported by the bridge of the primary frame to allow the body of the bridge of the auxiliary frame in contact with the bridge of the primary frame and the magnetic member of the bridge of the auxiliary frame to engage the bridge of the primary frame such that the auxiliary frame is disposed in front of the primary frame with each lens of the first pair of lenses being substantially in alignment with a respective lens of the second pair of lenses.

2. The auxiliary frame according to claim 1, wherein the lenses of the first pair of lenses have different or same optical characteristics.

3. The auxiliary frame according to claim 1, wherein the first pair of lenses are eyeglass lenses or sunglass lenses.

4. The auxiliary frame according to claim 1, wherein the magnetic member of the auxiliary frame is a magnet.

5. The auxiliary frame according to claim 1, wherein the bridge of the primary frame is made from steel such as stainless steel.

6. The auxiliary frame according to claim 1, wherein the bridge of the primary frame comprises:
a. a body having an inside surface and an opposite outside surface;
b. a housing formed on the inside surface of the body, wherein the housing has a mouth and a bottom defining a socket therebetween; and
c. a magnetic member secured in the socket,
when the auxiliary frame is engaged with the primary frame, the magnetic member of the bridge of the auxiliary frame engages with the magnetic member of the bridge of the primary frame to separate the magnetic member of the bridge of the primary frame from the ambient air.

7. The auxiliary frame according to claim 6, wherein the magnetic member of the primary frame is a magnet.

8. An eyeglass device having a first and second pairs of lenses, comprising:
a. a primary frame comprising:
(i). a first rim for holding one lens of a first pair of lenses;
(ii). a second rim for holding the other lens of the first pair of lenses; and
(iii). a bridge connecting the first rim and the second rim, wherein the bridge of the primary frame comprises:
a. a body having an inside surface and an opposite outside surface;
b. a housing formed on the inside surface of the body, wherein the housing has a mouth and a bottom defining a socket therebetween; and
c. a magnetic member secured in the socket; and
b. a auxiliary frame comprising:
(i). a first rim for holding one lens of the second pair of lenses;
(ii). a second rim for holding the other lens of the second pair of lenses;
(iii). a bridge connecting the first rim and the second rim, the bridge comprising:
a. a body extending horizontally and terminating at a first end and an opposite second end, the body having a top portion and a bottom portion, a socket located between the top portion and the bottom portion, and a magnetic member secured in the socket;
b. a first arm located at the first end of the body and projecting forward from the top portion of the body to be attached with the first rim; and
c. a second arm located at the second end of the body and projecting forward from the top portion of the body to be attached with the second rim; and
when the auxiliary frame is engaged with the primary frame, the first and second arms of the bridge of the auxiliary frame project over and is supported at least by the bridge of the primary frame to allow the body of the bridge of the auxiliary frame in contact with the bridge of the primary frame and the magnetic member of the bridge of the auxiliary frame to engage with the magnetic member of the bridge of the primary frame to separate the magnetic member of the bridge of the primary frame from the ambient air such that the auxiliary frame is disposed in front of the primary frame with each lens of the second pair of lenses being substantially in alignment with a respective lens of the first pair of lenses.

9. The eyeglass device according to claim 8, wherein the first pair of lenses and the second pair of lense have same or different optical characteristics.

10. The eyeglass device according to claim 9, wherein each pair of the first pair and the second pair of lenses are eyeglass lenses or sunglass lenses.

11. The eyeglass device according to claim 8, wherein the magnetic member of the primary frame is a magnet.

12. The eyeglass device according to claim 8, wherein the magnetic member of the auxiliary frame is a magnet.

13. The eyeglass device according to claim 8, wherein each of the first arm and the second arm of the auxiliary frame forms a U-type hook structure with the body of the bridge of the auxiliary frame and one of the first rim and the second rim of the auxiliary frame, with one of the rims of the auxiliary frame and the body of the bridge of the auxiliary frame being the two legs of the U-type hook structure, and one of the arms of the auxiliary frame being the bottom bar of the U-type hook structure, respectively.

14. An eyeglass device having a primary frame adapted to receive a first pair of lenses and an auxiliary frame adapted to receive a second pair of lenses and be supported on the primary frame, the primary frame having a first rim and a second rim to hold the first pair of lenses, and the auxiliary frame having a first rim and a second rim to hold the second pair of lenses, the eyeglass device comprising:
a. a first bridge connecting the first rim and the second rim of the primary frame, wherein the first bridge comprises:
(i) a body having an inside surface and an opposite outside surface;
(ii) a housing formed on the inside surface of the body, wherein the housing has a mouth and a bottom defining a socket therebetween; and
(iii) a magnetic member secured in the socket; and
b. a second bridge connecting the first rim and the second rim of the auxiliary frame, wherein the second bridge comprises:
(i) a body extending horizontally and terminating at a first end and an opposite second end, the body having a top portion and a bottom portion, a socket located between the top portion and a bottom portion, and a magnetic member secured in the socket;
(ii) a first arm located at the first end of the body and projecting forward from the top portion of the body to be attached with the first rim; and
(iii) a second arm located at the second end of the body and projecting forward from the top portion of the body to be attached with the second rim; and
when the auxiliary frame is engaged with the primary frame, the first and second arms of the bridge of the auxiliary frame project over and is supported at least by the bridge of the primary frame to allow the body of the bridge of the auxiliary frame in contact with the bridge of the primary frame and the magnetic member of the bridge of the auxiliary frame to engage with the magnetic member of the bridge of the primary frame to separate the magnetic member of the bridge of the primary frame from the ambient air such that the auxiliary frame is disposed in front of the primary frame with each lens of the first pair of lenses being substantially in alignment with a respective lens of the second pair of lenses.

15. The eyeglass device according to claim 14, wherein the magnetic member of the primary frame is a magnet.

16. The eyeglass device according to claim 14, wherein the magnetic member of the auxiliary frame is a magnet.

17. The eyeglass device according to claim 14, wherein each of the first arm and the second arm of the second bridge forms a U-type hook structure with the body of the second bridge and one of the first rim and the second rim of the auxiliary frame, with one of the rims of the auxiliary frame and the body of the second bridge being the two legs of the U-type hook structure, and one of the arms of the second bridge being the bottom bar of the U-type hook structure, respectively.
